(19) United States
(12) Patent Application Publication
(10) Pub. No.: US 2004/0193484 A1
(43) Pub. Date: Sep. 30, 2004

(54) Hyper advertising system

(75) Inventor: Lee Allen, San Jose, CA (US)

Correspondence Address: Brinks Hofer Gilson & Loine, NBC Tower, Suite 3600, P.O. Box 10395, Chicago, IL, 60610, US

(73) Assignee: DoCoMo Communications Laboratories USA, Inc.

(21) Appl. No.: 10/400,299

(22) Filed: Mar. 26, 2003

(51) Int. Cl. G06F 17/60

(52) U.S. Cl. 705/14

(57) ABSTRACT

The Hyper Advertising System includes a Hyper Operator that provides services for communication devices, customers who possess the devices, and vendors. The Hyper Operator receives advertisements from the vendors and uses a combination of data mining tools and a customer database, along with contextual information about subscribers, to generate acceptable recipients and transmit the advertisements to these recipients. Recipients forward the advertisement to other customers of the Hyper Operator known by the recipient to be possibly interested in the advertisement. The recipients who refer the advertisements to other customers are compensated.

### BACKGROUND

1. This application relates to a hyper advertising system. More specifically, this application relates to a hyper advertising system in which a Hyper Operator receiving advertisements from vendors uses a combination of data mining tools and a database with contextual information about subscribers to select recipients of the advertisements and recipients who refer the advertisements to other customers are compensated.

### 2. BACKGROUND INFORMATION

With the advent of wireless communication devices, such as cellular telephones or PDAs, access to the internet is now increasingly mobile. Mobile wireless customers have traditionally been connected to only one network operator, with both basic services such as voice communications and enhanced services such as Internet access provided by that network operator.

In the future, however, Hyper Operators, which are carriers that may or may not own their own infrastructure, will make a wider variety of services available to their customers, and these services will be provided by a many different third parties, including many different infrastructure operators in a heterogeneous access environment. This heterogeneous access environment includes the different operators as well as multiple users of different types of devices, each of which may use a different communication format. Despite the various environments and services that will be present, the customer will contract with the Hyper Operator and will expect all dealings to be with the Hyper Operator, regardless of how many operators and other providers are involved in the provision of services. This is true no matter what type of communication system is being used: mobile or not, wireless or wired.

The Hyper Operator may own or have access to customer information that would enable third-party vendors to better reach customers, while simultaneously increasing advertising yields by focusing the advertisement effort to likely purchasers. Such a Hyper Advertising System can thus be of benefit to not only the third-party vendor, but in addition to the customer, who may be interested in the particular goods or services provided by the third-party vendor, and the Hyper Operator, who may increase his revenue.

### BRIEF SUMMARY

To achieve the above objectives and obtain the advantages disclosed herein, means of advertising are disclosed.

The method comprises compensating customers having an account with a Hyper Operator that provides services for communication devices (mobile, non-mobile, wireless, or wired) possessed by the customers for forwarding vendor advertisements to recipients who are other customers of the Hyper Operator and are known by the customers to be possibly interested in the advertisements, thereby referring the advertisements to the recipients. The Hyper Operator amasses a database of characteristics and context information of the customers of the Hyper Operator.

The method may comprise the Hyper Operator independently generating pre-qualified leads based on characteristics of a particular advertisement, characteristics of a given customer, and context information of the given customer. In this case, the Hyper Operator sends an advertisement to one of the pre-qualified leads. The method may further comprise using only characteristics of the given customer made known by the given customer.

The method may comprise the Hyper Operator receiving an indication from an original customer that a particular advertisement is to be forwarded, as well as an intended recipient of the particular advertisement, and forwarding the particular advertisement to the intended recipient. In such an embodiment, the method may further comprise the Hyper Operator marking the particular advertisement delivered to the intended recipient as being forwarded from the original customer. Similarly, the Hyper Operator may credit the account of the original customer with a pre-arranged amount of microcredits and a corresponding amount of microdebits for the vendor when the intended recipient perceives the particular advertisement and issuing a credit to the account of the original customer when the microcredits accumulated by the original customer reach a predetermined amount. Further still, the Hyper Operator may permit the predetermined amount of microcredits to be selectable by the original customer.

The method may comprise the Hyper Operator marking advertisements as being forwarded from an original customer before the recipients perceive the advertisements.

The method may comprise the Hyper Operator independently determining suitable prospects from a collection of customers each of which has individually indicated a willingness to receive specific types of advertisements to the Hyper Operator and sending referrals to the customers in the collection. In such an embodiment, the Hyper Operator may accumulate and aggregate context-aware purchase histories of the customers in the collection over time and use the accumulated information, along with proprietary tools and databases related to data mining and context-aware computing, to synthesize and present additional referrals to subscribing customers.

The method may comprise the Hyper Operator using context information in storage of purchase histories of the customers and in decisions regarding whether and in what way to make new referrals.

The method may comprise the Hyper Operator providing information of an individual customer to vendors only if a recipient of a referral acts on the referral (e.g. purchases an item using the advertisement).

The method may comprise limiting contact between the vendor and both the Hyper Operator and the customers of the vendor such that the vendor does business with the Hyper Operator for offer presentation and only sees orders from one of the customers and the Hyper Operator.

The method may comprise the Hyper Operator managing dynamic sale states in which sales are initiated, promoted via referrals, and cancelled at any time according to parameters of the Hyper Operator.

The method may comprise a given vendor compensating the Hyper Operator a fee for each advertisement delivered to the customers. Similarly, the method may comprise instituting a calling-party-pays system in which customers who refer advertisements to recipients are charged by the Hyper Operator for each referral.

The method may comprise allowing each customer to receive a particular advertisement only once. Similarly, the method may comprise limiting a number of allowable referrals and decreasing the number of allowable referrals each time the advertisement is referred. Alternatively, the method may comprise compensating only a limited number of customers for referrals to one of an original customer first receiving a particular advertisement for referring the particular advertisement to referral customers and both the original customer and the referral customers for subsequent referrals, a later customer to whom the advertisement has been referred and who provides a referral being compensated at a reduced value as a function of generational distance from the referring customer.

In another embodiment, a method of advertising comprises a vendor sending an advertisement to a referring customer of a Hyper Operator that provides services for a communication device (mobile, non-mobile, wireless, or wired) possessed by the referring customer with the advertisement having parameters set by the vendor and being sent via the Hyper Operator to the communication device. The Hyper Operator uses the advertising parameters and a customer database of the Hyper Operator that includes information regarding offer parameters acceptable to customers in the database and context information of the customers to generate acceptable recipients. The Hyper Operator transmits the advertisement to the acceptable recipients. A referring customer of the acceptable recipients forwards the advertisement to a referral customer of the Hyper Operator known by the referring customer to be possibly interested in the advertisement. The referring customer is compensated for forwarding of the advertisement to the referral customer.

The referral customer may be added as input and the Hyper Operator using the customer database to generate a set of additional acceptable recipients and transmitting the advertisement to the additional acceptable recipients.

The referral customer may forward the advertisement to a secondary referral customer of the Hyper Operator known by the referral customer to be possibly interested in the advertisement, the secondary referral customer added as input, with the Hyper Operator using the customer database to generate a second set of additional acceptable recipients, transmitting the advertisement to the additional acceptable recipients, and compensating the referral customer for forwarding of the advertisement.

The referring customer may be compensated only after the referral customer perceives the advertisement. Similarly, the referring customer may be compensated only for referral customers directly referred to by the referring customer. Alternatively, the referring customer may be compensated only for referral customers directly referred to by the referring customer and a limited number of additional referral customers indirectly referred to by the referring customer, the compensation to the referring customer for the additional referral customers indirectly referred to by the referring customer being limited by permitting compensation for a maximum number of indirect referrals that decrease and eventually stop with increasing generational distance from the referring customer.

The compensation may be accomplished by sending accounting information about the referring customer to the Hyper Operator and generating a microcredit for the referring customer and a corresponding microdebit for the vendor. In this case, the vendor may accumulate microdebits, the Hyper Operator billing the vendor for the accumulated microdebits and clearing the accumulated microdebits on a periodic basis. Similarly, the referring customer may accumulate microcredits, the Hyper Operator crediting the referring customer for the accumulated microcredits and clearing the accumulated microcredits when a money value of the microcredits reaches a predetermined level.

Each customer may be allowed to receive a particular advertisement only once.

A calling-party-pays system may be instituted in which customers who refer advertisements to recipients are charged by the Hyper Operator for each referral and/or the number of allowable referrals generated by each customer may be limited and the number of allowable referrals decreased with increasing generational distance from the referring customer. Only the referring customer may be compensated originally receiving the advertisement from the vendor for any referrals or both the referring customer originally receiving the advertisement from the vendor for any referrals and referred customers for subsequent referrals. In this case, a later customer to whom the advertisement has been referred and who provides a referral is compensated at a reduced value as a function of generational distance from the referring customer.

The Hyper Operator may learn from customer referral and purchasing behavior to create a store of specialized knowledge about customers. This store of specialized knowledge about customers may be used to enhance vendor initiatives, to select additional referrals beyond referrals initiated by the customers, and/or to more customize a nature, form, timing, and content of referrals.

The advertisements may be marked as being forwarded from the referring customer before the referral customer perceives the advertisement.

In another embodiment, the method of advertising comprises a vendor sending an advertisement to a referring customer of a Hyper Operator that provides services for a communication device (mobile, non-mobile, wireless, or wired) possessed by the referring customer with the advertisement having parameters set by the vendor and being sent via the Hyper Operator to the communication device. The Hyper Operator uses the advertising parameters and a customer database of the Hyper Operator that includes information regarding offer parameters acceptable to customers in the database and context information of the customers to generate acceptable recipients and transmits the advertisement to the acceptable recipients. A referring customer of the acceptable recipients then forwards the advertisement to referral customers of the Hyper Operator known by the referring customer to be possibly interested in the advertisement and the Hyper Operator compensates a limited number of customers for referrals. The compensation is limited to compensating only the referring customer for forwarding of the advertisement to the referral customers only after the referral customers perceive the advertisement or compensating both the referring customer and the referral customers for subsequent referrals only after the subsequent referrals perceive the advertisement. A later customer to whom the advertisement has been referred and who provides a referral is compensated at a reduced value as a function of generational distance from the referring customer.

A calling-party-pays system may be instituted in which customers who refer advertisements to recipients are charged by the Hyper Operator for each referral.

The Hyper Operator may add the referral customers as input, use the customer database to generate a set of additional acceptable recipients, and transmit the advertisement to the additional acceptable recipients. Similarly, the Hyper Operator may add the subsequent referrals as input, use the customer database to generate a second set of additional acceptable recipients, and transmit the advertisement to the additional acceptable recipients.

The referring customer may be compensated by sending accounting information about the referring customer to the Hyper Operator and generating a microcredit for the referring customer and a corresponding microdebit for the vendor, the vendor accumulating microdebits, the Hyper Operator billing the vendor for the accumulated microdebits and clearing the accumulated microdebits on a periodic basis, the referring customer accumulating microcredits, the Hyper Operator crediting the referring customer for the accumulated microcredits and clearing the accumulated microcredits when a money value of the microcredits reaches a predetermined level.

The Hyper Operator may allow each customer to receive a particular advertisement only once. Similarly, the Hyper Operator may limit the number of allowable referrals generated by each customer and decrease the number of allowable referrals with increasing generational distance from the referring customer.

The Hyper Operator may learn from customer referral and purchasing behavior to create a store of specialized knowledge about customers. This store of specialized knowledge about customers may be used to enhance vendor initiatives, to select additional referrals beyond referrals initiated by the customers, and/or to more customize a nature, form, timing, and content of referrals.

In another embodiment an electronic unit (alternately called a terminal or device) houses a Hyper Operator that provides services for communication devices possessed by customers having an account with the Hyper Operator. The electronic unit comprises a transmitter/receiver through which the electronic unit communicates with external sources including vendors and the customers, the transmitter/receiver configured to receive advertisements with parameters set by the vendor and transmit the advertisements to selected customers; a memory that is configured to amass a customer database of characteristics and context information of the customers; a processor that is configured to use the customer database and advertisement parameters to determine referring customers to whom the advertisements are transmitted and configured to set compensation for the referring customers who refer advertisements to referral customers known by the referring customers to be possibly interested in the advertisements; and an interface through which internal elements of the electronic unit communicate.

The customer database maintained by the memory may include information regarding offer parameters acceptable to the customers. The Hyper Operator may limit a total number of referral customers from each of the referring customers or only allow a particular customer to receive a particular advertisement once. The Hyper Operator may also limit the compensation to only the referring customers or to both the referring and referral customers who subsequently refer the advertisements to other customers. The compensation to referral customers may be reduced as a function of generational distance from the referring customer.

The memory may include characteristics and context information of the customers, with the Hyper Operator independently generating pre-qualified leads based on the characteristics and context information of the customers stored in the memory and characteristics of a particular advertisement, and transmits the particular advertisement to the pre-qualified leads. The characteristics and context information of the customers that are stored in the memory may include a willingness specified by each customer to receive specific types of advertisements. Similarly, the memory may include an accumulation and aggregation of context-aware purchase histories of the customers over time and the Hyper Operator use the accumulated information, along with proprietary tools and databases related to data mining and context-aware computing, to synthesize and present additional referrals to subscribing customers.

The Hyper Operator may use context information contained in the memory in storage of purchase histories of the customers and in decisions regarding whether and in what way to make new referrals, isolate the customers and the vendors such that information of a particular customer is provided to a particular vendor only if the particular customer acts on an advertisement of the particular vendor, manage dynamic sale states in which sales are initiated, promoted via referrals, and cancelled at any time according to information stored in the memory, or receive an indication from one of the referring customers that a particular advertisement is to be forwarded as well as an intended referral customer of the particular advertisement, mark the particular advertisement as being forwarded from the one of the referring customers, and forward the particular advertisement to the intended referral customer.

Turning to finances, the Hyper Operator may credit an account of a particular referring customer with a pre-arranged amount of microcredits and debit a corresponding amount of microdebits from an account of a particular vendor for each advertisement of the particular vendor forwarded by the particular referring customer that qualifies for crediting and debiting (e.g. by reading the referral customer reading or otherwise perceiving the advertisement) and issue a credit to the account of the particular referring customer when the microcredits accumulated by the particular referring customer account reach a predetermined amount. The credits, microcredits, debits, and microdebits are stored in the memory. The Hyper Operator may indicate to the particular referring customer when the credit has been issued, charge a particular vendor compensation for each advertisement of the particular vendor that is delivered to the customers, or institute a calling-party-pays system in which the referring customers who refer advertisements to the referral customers are charged for each referral.

### BRIEF DESCRIPTION OF THE DRAWINGS

FIG. 1 shows a first step in a first embodiment;

FIG. 2 shows a second step in the first embodiment;

FIG. 3 shows a third step in the first embodiment;

FIG. 4 shows a fourth step in the first embodiment;

FIG. 5 shows a fifth step in the first embodiment;

FIG. 6 shows a sixth step in the first embodiment;

FIG. 7 shows revenue flow according to the first embodiment.

### DETAILED DESCRIPTION OF THE DRAWINGS AND THE PRESENTLY PREFERRED EMBODIMENTS

Customers of communication or computer networks typically have an ongoing need for relevant and targeted information. Mobile customers, in particular, have a heightened need for such information, both in terms of time as they travel from one location to another and cost as targeted information requires less overall information to be transferred and thus less connection time. Hyper Operators may provide network-based (such as Internet-based) services that incorporate personal information about the customer such as age, job, and marital status. In addition, other information regarding preferences of the user, frequently visited Internet sites or recent purchases on various sites for example, may be incorporated into the service requested.

However, although from time-to-time reference will be made specifically to mobile or wireless communication networks, the Hyper Operators discussed may be associated with any type of communication network: mobile, fixed, wired, or wireless. For example, mobile customers may use any wireless communication device such as a cellular telephone or personal digital assistant.

Such a system can further streamline both the parameters and responses of the service by using information based on the context of the customer. This is more fully described in U.S. patent application Ser. No. 10/134,814 filed Apr. 29, 2002 in the names of Lee Allen, Toshio Miki, and Shahid Shoaib and entitled “Context Aware Search Service,” commonly assigned to the assignee of the present application, which is incorporated herein by reference in its entirety.

In short, context-aware services are services whose operation is affected in some way by: the context of the user, external context, or the characteristics or context of the device used by the customer. Examples of the context of the user include customer identity, present activity in which the customer is engaged, physical location, schedule/agenda, and usage habits. Examples of the external context include the time of day, nearby people, or other nearby activity. Examples of the characteristics or context of the device used by the customer include computing capabilities, display capabilities, or proximity to other devices with resources available for sharing. Thus, the Hyper Operator may own or have access to a large amount of both customer-specific and context-specific information.

Previously, customization of results has been considered, often at the level of simple formatting or whether or not to send information based on the receiver's physical location. In contrast, the service described herein provides integration of real-time contextual information in order to personalize both the request and the response (to the user and/or the type of network being used). Additionally, there is little to no activity in the area of integration of context sensing and analysis for the purpose of application; specifically, as concerns the present application, towards advertising.

Despite this previous lack of activity in application-oriented usage of the integrated information, the concentration of customer-specific and context-specific information at the Hyper Operator creates an opportunity to provide a service that greatly expands third-party vendors' capabilities to reach customers, while simultaneously increasing advertising yields by focusing the advertisement effort to likely purchasers. In the future, advertising may well evolve from a vendor-initiated broadcasting model to a customer-initiated targeted-search model. The initial stages of purchasing behavior may increasingly involve searches through complex information for a specific reason, and notification of pre-specified opportunities via agents. This trend is already apparent with the rise of searching on the internet and will likely grow to become the dominant mode of purchaser behavior. The Hyper Advertising System disclosed herein provides technology that leverages human relationships and knowledge in this effort. The Hyper Advertising System can be of benefit to not only the third-party vendor, but in addition to the customer and the Hyper Operator.

The system described herein uses the principles of viral marketing and context-aware services, along with the Hyper Operator's internal processing, to enable third-party vendors to reach a larger number of better-focused customers. Viral marketing describes any strategy that encourages individuals to pass on a marketing message to others, creating the potential for exponential growth in the message's exposure and influence.

In the instant system, the Hyper Operator generates pre-qualified leads of specific sets of customers based on characteristics of the advertisement via proprietary tools, characteristics of customers (as made known by the customer), and the contextual situation of a given customer at a given time and forwards the vendor advertisements to acceptable customers. Customers who receive the advertisements are paid to forward advertisements to their friends and/or associates. The conjunction of context and consumer information at the Hyper Operator permits the Hyper Operator to modify the content, timing, format and selection of the advertisement (i.e. contextualization as well as presentation of the advertisement) as a result of the overall information available.

In one embodiment of the Hyper Advertising system, when the original referring customer sees an advertisement that he/she judges to be of possible interest to a recipient known by the referring customer, the referring customer indicates to the Hyper Operator this by an appropriate operation, such as pressing a designated button on the terminal used, and specifies the intended recipient of the advertisement (of course oral statements may be used for voice-activated systems). The advertisement is then sent to the specified recipient and may be marked as being forwarded from the original customer. In general, the specified recipient is a referral customer, that is, a customer who subscribes to the same Hyper Operator as the referring customer. Alternatively, if a number of Hyper Operators are associated or otherwise have a relationship (for example, in which some customer information is shared), the referring and referral customers are not required to be subscribers to the same Hyper Operator. In such a case, however, each Hyper Operator must be careful to avoid sending large amounts of advertisements to not only its customers, but also customers of associated Hyper Operators. The Hyper Operator can easily keep track of this data and take appropriate action when parameters set by the Hyper Operator are exceeded.

When the referring customer forwards an advertisement to the referral customer and the referral customer perceives the advertisement, e.g. reads or listens to the advertisement, the forwarding customer is credited with a pre-arranged amount of microcredits. To credit the referring customer when the referral customer perceives the advertisement rather than when the advertisement is sent, in one embodiment the device or terminal that the referral customer is using signals the Hyper Operator when the referral customer opens a piece of email containing the advertisement. When accumulated microcredits reach a predetermined amount, the referring customer is compensated: a credit is issued to the customer's Hyper Operator account. Customers may select the amount at which accumulated microcredits roll-over into the customer's account or the amount may be predetermined by the Hyper Operator. The specific currency equivalence of a microcredit is a pricing issue that will not be further described here. Microcredits, microdebits and the like may also be doled out only when a recipient actually purchases the product or service.

Independently, the Hyper Operator makes a determination of suitable prospects via proprietary tools from a collection of customers who have indicated by subscribing to the service that they are willing to receive specific types of advertisements, and also sends referrals to those customers. The system accumulates and aggregates the context-aware purchase histories of this collection of customers over time, and uses the accumulated information, along with its proprietary tools and databases related to data mining and context-aware computing, to synthesize and present additional referrals to subscribing customers. The data is aggregated in order to eliminate privacy issues, and to discover and present new potential ad-hoc markets to sellers.

Methods relating to context are employed in two separate areas of the system: in the way that the purchase histories are stored, i.e. context-sensitive data, and in the decisions regarding whether and in what ways to make new referrals, i.e. context-aware computing.

Some of the benefits for the vendor include having an advertisement that is targeted or localized to a specific audience. Targeting the advertisement to a prospective receptive audience is more effective, less costly, and less widespread, which also translates into not decreasing the good will of the particular vendor as much as conventional spam advertisements.

More specifically, vendors realize higher yields from their marketing expenditures, because each vendor-initiated advertising exposure results in subsequent exposures that should be more tightly targeted to the prospective buyer. Subsequent exposures are also more tightly targeted not only because friends and associates are likely to share interests, but also because friends and associates are likely to know about each other's interests even if they do not share them, and the original referring customer does not need to share a given interest with the friend or associate in order to forward an advertisement to them. Thus, for example, if an original referring customer receives a sports-related advertisement and that customer is not an active sports fan, the customer might still forward the advertisement to a friend who is known by that customer to be an active sports fan.

Furthermore, a significant and unique advantage to vendors is the dramatic reduction in marketing expenses caused by the Hyper-Operator-created referrals. The Hyper Operator has already performed the marketing pre-qualification for the vendor, and the vendor does business with the Hyper Operator for offer presentation and only sees orders.

Instead of conducting static sales or offer periods, the vendor can let the Hyper-Operator manage dynamic sale-states during which referrals can be made according to appropriate prospects, according to the Hyper Operator's parameters. Such states can be initiated, promoted via referrals, and cancelled at any time. Thus, the offers exist only as long as they are relevant and useful, and the vendor does not have to worry about the problems that frequently result from conducting static sales with physical artifacts such as paper coupons, an example being the vendor receiving a coupon months or years after the end of the promotion resulting in either a loss in good will for not honoring these coupons or an unanticipated loss in profits if the coupon is honored.

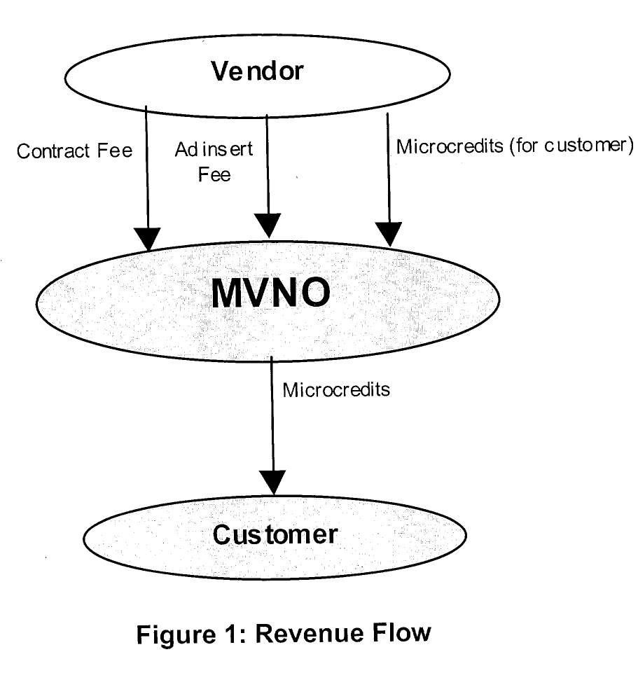

Concurrently, the Hyper Operator benefits from increased revenue and enhanced information regarding both the original referring and subsequent referral customers. The revenue may be increased by essentially selling the use of the database system and selection techniques (both proprietary and non-proprietary) by the Hyper Operator to the vendor in order to target and send the advertisements to particular customers of the Hyper Operator. The Hyper Operator may increase revenue by charging a set contract fee to the vendor when the vendor initially signs up to be able to send advertisements to the Hyper Operator, charging a set premium per advertisement and/or per person the advertisement is forwarded to by the Hyper Operator and/or customers of the Hyper Operator. If the Hyper Operator provides microcredits to a referring customer, the Hyper Operator may also increase its revenue by debiting a corresponding amount of microdebits from the vendor and, in addition, a small premium to itself. Thus, for example if the referring customer receives 10 microcredits, the vendor gets charged 11 microdebits, with 10 microdebits being used to pay the 10 microcredits and the additional 1 microdebit going to the Hyper Operator. The use of microcredits and microdebits greatly reduces the risks associated with billing and settlement based on the movement of funds outside the control of the Hyper Operator. FIG. 1 shows the revenue flow in one embodiment.

The customers benefit by receiving coupons or sale notices of the goods or services targeted to interests of the specific customer and provided by the vendor. Thus, the customers enjoy new promotions tailored to their existing behavior, to their contextual information, and to the preferences that they have made known to their friends and associates. These customers benefit from their friends and associates' combined awareness of interesting opportunities. Moreover, there is less need to expose an individual customer's information to vendors unless the customer decides to act on the referral. Thus the customer receives fewer cold-call and/or inappropriate advertising messages, i.e. annoying spam.

This system also employs an underlying mechanism that makes the sending customer pay for messaging services. Although this situation is not presently the case in the United States, in which the called party pays, many industry experts believe that the future trend is toward calling-party-pays systems. In these calling-party-pays systems, the cost associated with referring (at a minimum, packet cost) may mitigate the tendency toward referral spamming, which is described below.

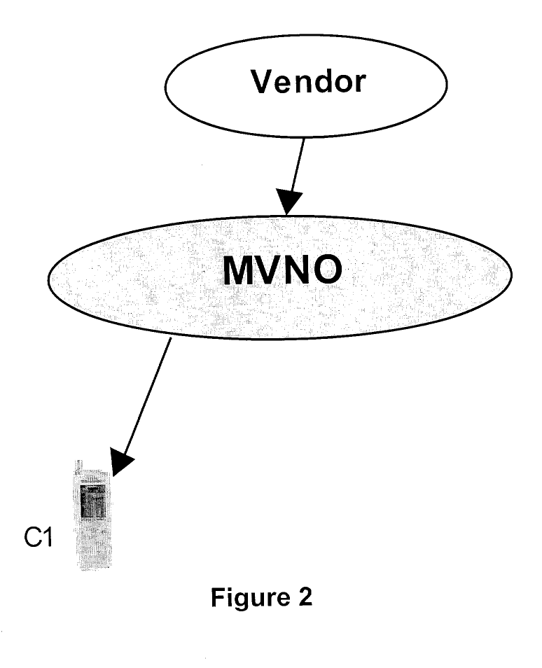

Table 1 shows the entities involved in provision of the Hyper Advertising service. The general method of the Hyper Advertising system described is illustrated in FIGS. 2-7.

In FIG. 2, the vendor sends an advertisement to an original, referring customer (C1). The vendor may use any type of communication system, such as that of FIG. 8, albeit with somewhat different software.

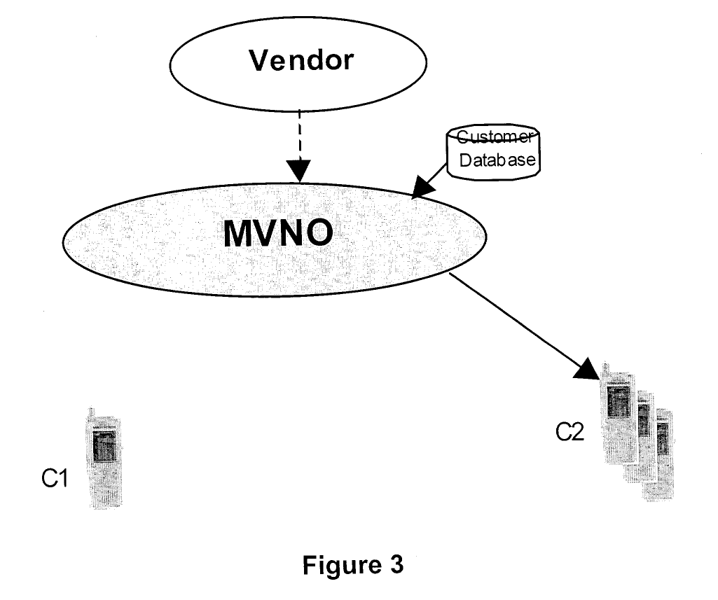

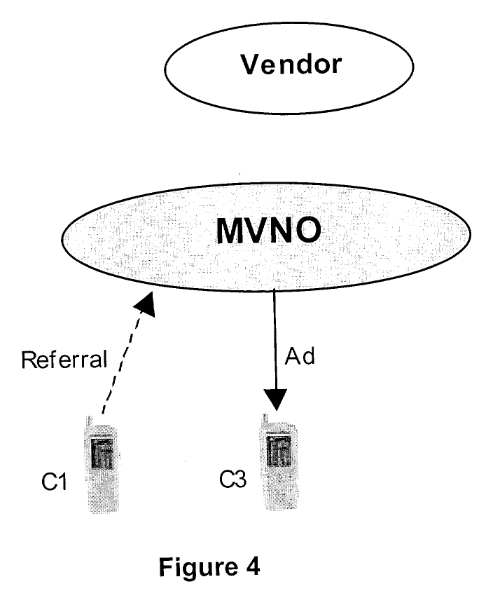

Using the vendor's advertisement parameters as input, the Hyper Operator uses both standard and proprietary data-mining tools as well as its customer database to generate additional referrals. The customer database includes information regarding offer parameters acceptable to customers as well as contextual data regarding the customers. As shown in FIG. 3, the advertisement is then sent to these additional referral customers (C2). During approximately this same time, referring customer C1 forwards the ad to a referral customer (C3), as indicated in FIG. 4. The referring customer C1 uses a device capable of communication with the Hyper Operator.

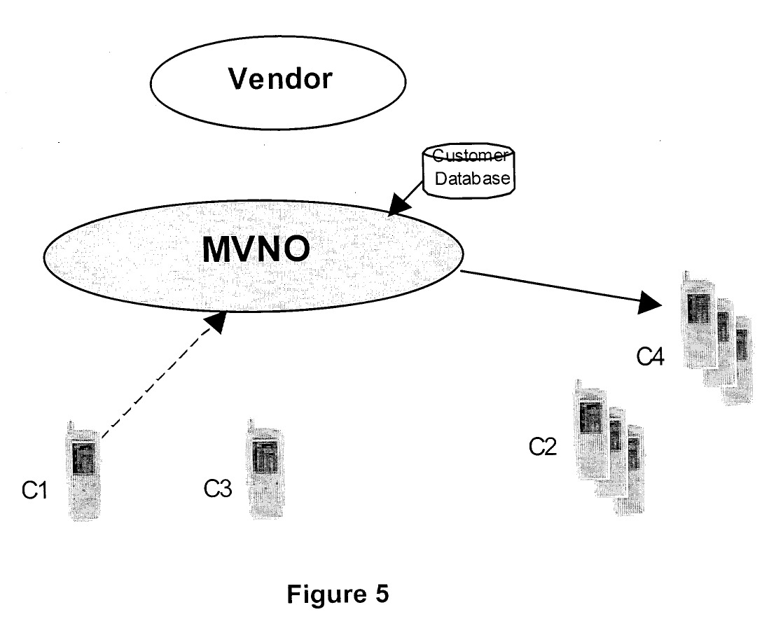

FIG. 5 shows that the Hyper Operator generates a second set of referral customers using the original customer's referral as input, as well as the above-mentioned standard and proprietary data-mining tools and its customer database, including information regarding offer parameters acceptable to customers. The advertisement is then sent to these additional referral customers (C4). In fact, each time a referral is sent to the central data location, i.e. Hyper Operator, the Hyper Operator provides intermediary services such as generating additional sets of referrals based on the new referral or creation/update of the store of specialized information that exists at the Hyper Operator.

TABLE 1

| | | VALUE | ENTITY | ENTITY |
|---|---|---|---|---|
| ENTITY | DESCRIPTION | TO ENTITY | PAYS | PAID BY |
| Vendor | Originator of | Transaction Revenue | Hyper | |
| | advertisement | Higher Ad Yields | Operator | |
| | | Reduced Advertising | (contract fee, | |
| | | Cost | ad insert fee, | |
| | | Reduced Overhead | micro-credits, | |
| | | and Tasks | on behalf of | |
| | | Access To Additional | forwarding | |
| | | Qualified Customers | customer) | |
| Hyper | Proxy acting on | Customer Retention | | Vendor |
| Operator | the behalf of | Vendor Contract Fees | | (contract |
| | customers | Ad Insert fees | | fee plus ad |
| | | Traffic Fees | | insert |
| | | | | fees) |
| Referring | Customer who | Microcredits | | Vendor |
| Customer | forwards the | Goodwill | | (microcredits) |
| | advertisement | Network of associates | | |
| | | looking for good deals | | |
| Referral | Customer who | Tightly-targeted offers | | |
| Customer | receives the | Personal information | | |
| | forwarded | kept private | | |
| | advertisement | Network of associates | | |
| | | looking for good deals | | |

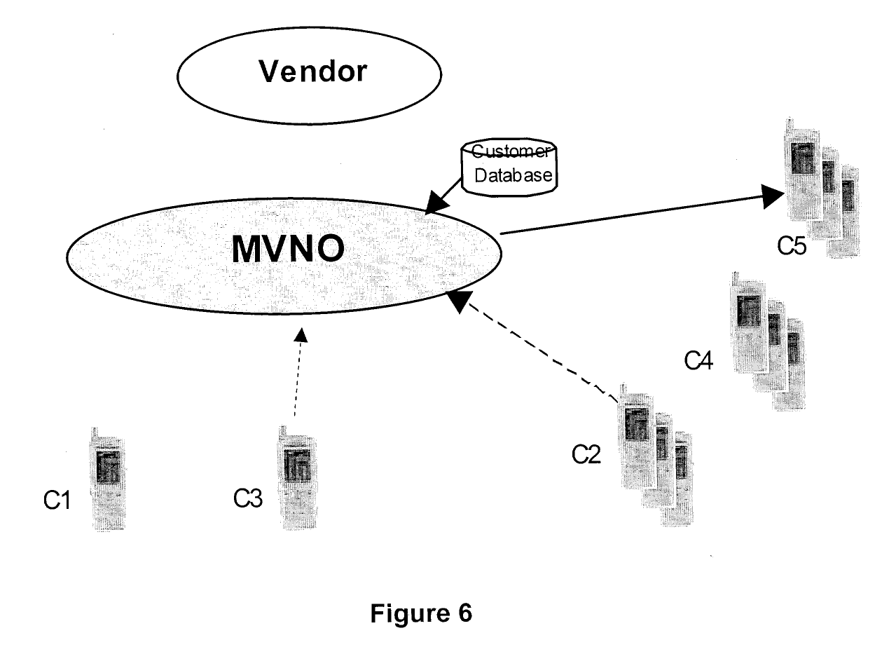

As illustrated in FIG. 6, if a referred customer of either the original customer or the Hyper Operator (C2 or C3) makes a secondary referral, the Hyper Operator again uses the standard and proprietary data-mining tools and its customer database, including information regarding offer parameters acceptable to customers, to generate a second set of referrals. The advertisement is then sent to these additional customers (C5).

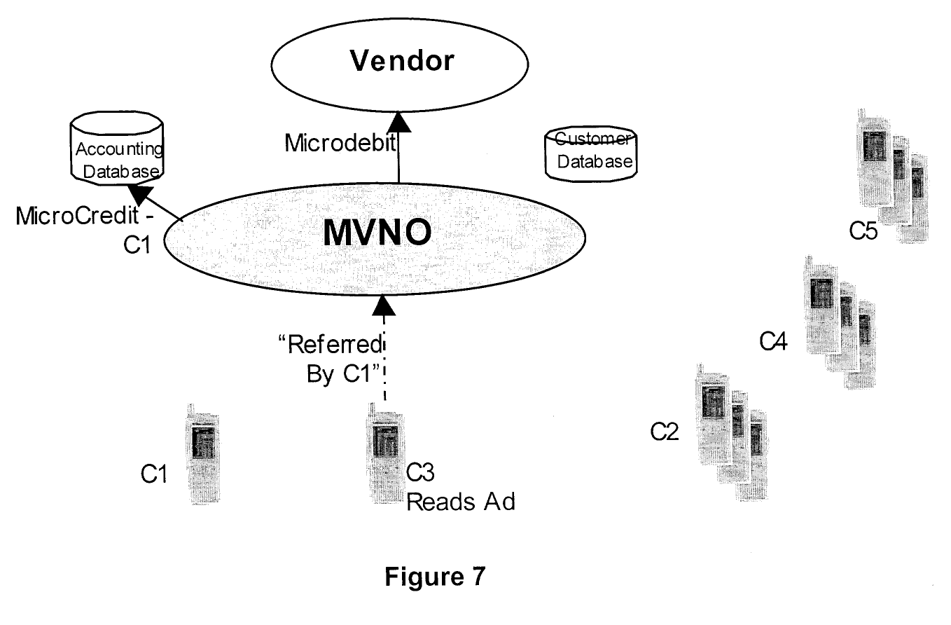

When a receiving customer that was directly referred by another customer (C3), for example, reads the advertisement, accounting information about the referring customer is sent to the Hyper Operator and is used to generate a microcredit for the referring customer and a corresponding microdebit for the vendor. This is shown in FIG. 7. Note that although not shown, if the referral customer actually uses the advertisement by, for example, using the electronic coupon and purchasing an offered good or service, the referring customer may receive additional microcredits to his or her account.

Microdebits are accumulated by vendor and cleared (billed) on a periodic basis. When the money value of a customer's microcredits reaches a predetermined level either preset by the Hyper Operator or preset by the customer, the value of that customer's microcredits is credited to that customer's Hyper Operator account and the credit is cleared.

The referrals may be personalized according to the user's current context—in terms of to the selection, timing of when the advertising is shown, output format of the advertisement, and actual content (e.g. 15% off rather than 10% off) of the referral. For example, a customer shopping at a mall might receive referrals that give competing advertisements and/or offers, and compare price/performance according to his buying preferences, purchase plans as known by the Hyper Operator, and based on the purchases that the customer has already completed during that visit to the mall.

Because of the characteristics of viral marketing, it is possible that several uncontrolled iterations of referral might result in an individual customer receiving many referrals of the same advertisement. In the most extreme scenario, most customers are receiving a great many copies of the same advertisement, with only the specific advertisement received varying from customer to customer. This situation would greatly reduce the appeal and usefulness of the system, both to customers and to vendors.

It is also possible, however, that subsequent referrals of a given advertisement may result in better prospects. For example, if a computer-software related advertisement were sent to a first customer who recently purchased software but was not an active computer enthusiast, the first customer might refer the advertisement to a second customer known to be a more active computer enthusiast—but it may turn out that the second customer is not interested in the specific class of software advertised. The second customer might then refer the advertisement to a third customer more specifically interested in the specific class of software, and so on.

To accommodate both of the considerations described above, an instantiation of the system may restrict the system so that a given customer may receive a given advertisement a limited number of times, preferably only once. This will allow multiple levels of referral for a given advertisement to allow affinity-based routing to deliver it to the most appropriate prospect but protect customers with well-known interests from referral storms in which the referral customer receives multiple copies of the same advertisement from different referring customers or the Hyper Operator.

In addition, the use of microcredits as incentive for referring advertisements creates the possibility that a customer may simply forward all advertisements received to everyone in the customer's phone-book file, with the hope of receiving some credit for a serendipitous sale. This is known as referral spamming. The notion is that any sale thus generated is better than nothing and referring is riskless to the extent that the action is costless. In reality however, there is a cost associated with referring (at a minimum, packet cost) which will mitigate the tendency toward referral spamming at least to some degree in a calling-party-pays system. In addition, one embodiment this system may include the following measures, either singly or in combination, to further control referral spamming:

(a) Limit the number of allowable referrals by each referring customer independently.

(b) Limit the number of allowable referrals by each referring customer and further decrease the number of allowable referrals each time the advertisement is referred (i.e. decrease the number of allowable referrals with increasing generation from the original referring customer).

In one example of (b), the customer who first receives the advertisement directly from the vendor may be allowed up to eight referrals, and a recipient of the advertisement from that customer may be allowed only four referrals, and so on until a recipient is allowed no referrals. This is conducted on a referral basis, not on a customer basis. The referrals are tagged, decremented, and re-tagged as they pass through the Hyper Operator's network. The decreasing number of allowable subsequent referrals for a given referral is made up by the exponentially growing number of identical referrals. In the above example, with one referral that allows eight subsequent referrals and the number of subsequent referrals after that decreasing by half, the following total referrals are possible by iteration:

| | | Allowable | |
|---|---|---|---|
| | # of | Subsequent | |
| Iteration | Referrals | Referrals | Result |
| 1 | 1 | 8 | 8 |
| 2 | 8 | 4 | 32 |
| 3 | 32 | 2 | 64 |
| 4 | 64 | 1 | 64 |
| | | Total | 168 |

Number of Active Referrals By Referral Iteration

Note that it is increasingly possible that a recipient of the advertisement will receive the same advertisement again from a different referring customer. Thus, an additional advantage of such an arrangement is that although a second (or later) generation recipient may not be able to send the advertisement to as many subsequent recipients, by decreasing the number of referrals it is less likely that a recipient of the advertisement will receive the same advertisement again from a different referring customer.

(c) Grant microcredits only for referrals made by the customers originally receiving the advertisement from the vendor.

(d) Grant microcredits for referrals subsequent to the original customer receiving the advertisement from the vendor, however reduce the value of the associated microcredit as a function of the order of the referral. In such case, a secondary referral (referred customer) would earn a smaller microcredit than that earned by a referral from the original customer (referring customer), a tertiary referral microcredit would be smaller than the secondary referral microcredit, and so on. This allows another degree in which the promotion can be tuned to fit the specific circumstances, similar to damping in a harmonic system. A heavily-damped system would grant credits for only the first referral and a more loosely-damped system would grant credits farther down the referral chain.

In addition to controlling referral spamming while still encouraging the affinity-based routing effect, the measures described above recognize the decreasing time value of the advertisement and help prevent vendor overexposure to microdebit charges. If vendors perceive that they are paying too much in microdebit charges, or that the amount of charges is unpredictable and/or unmanageable, the Hyper Advertising System will lose its appeal to vendors.

Other embodiments of the system may include:

Giving feedback regarding the effectiveness of referrals, by recipient: show referrers the win/loss rate for each target person, so they stop referring messages to people who either never read them or never buy the products advertised. Referrers would have two incentives: not wanting to unnecessarily antagonize people in their network by sending unwanted referrals, and not wanting to waste a referral on someone who never reads or responds.

Measuring the reputation of each individual as a referral source: the Hyper Operator could create a mechanism whereby potential customers express their satisfaction with each referred offer with a simple click of a button or oral statement (for voice-activated systems). This could help those making referrals to get better at it, so their reputation improves and the conversion rate of referred ads to purchases goes up.

Referral screening: The receiving customer sets up a profile at the Hyper-Operator and specifies parties from whom the receiving customer does not want to receive referrals. The Hyper-Operator monitors this information without sharing it with the referrer, and automatically blocks any referred ads that are targeted at a customer who does not want them from that referral source.

The Hyper Advertising system thus includes learning from customer referral and purchasing behavior to create a store of specialized knowledge about customers, which can then be used to enhance vendor initiatives. From this store of specialized knowledge, additional referrals are selected beyond those initiated by customers. Similarly, the store of specialized knowledge may be used to more deeply customize the nature, form, timing, and content of referrals. In addition, intermediary services, such as generation of additional references by the Hyper Operator or rating effectiveness of referrals for example, may be provided for customer-initiated advertising referrals.

In summary, the Hyper Advertising system provides functions beyond those presently included in traditional advertising systems. For example, most systems present today include some measure of referral incentive, but these systems do not combine viral marketing with system learning and new referral creation as performed by the Hyper Operator. Indeed, advantage of the Hyper Advertising system is the close management and augmentation of the viral-marketing process, while preserving the dynamic strengths and benefits of viral marketing.

An additional advantage of the Hyper Advertising system over traditional viral marketing or referral systems is the difference between relatively static customer profiles and the more dynamic, real-time contextual information used by the Hyper-Advertising system in the management and provision of services according to the real-time condition or situation in which the user is situated. Location is somewhat less static than customer profiles, but should not be confused with the rich set of contextual information that will be available in the ad-hoc, peer-to-peer-based communications and computing grid that will be available at the time of the Hyper Operator.

Embodiments of this system give the customer significant control over the customer's individual information, considering the potentially invasive perception given by the processing of customer purchase data. The Hyper Advertising system thus builds upon the Hyper Operator's role as the trusted advocate and proxy for the customer, while reflecting the realization that both vendors and consumers are customers of the Hyper Operator.

The Hyper Operator also provides the software and necessary hardware to enable the Hyper Advertising System, as per the requirements of the particular Hyper Operator and communication system used by the customers and vendors. Implementations and embodiments of the algorithms that control the above Hyper Advertising System include computer readable software code. These algorithms may be implemented together or independently. Such code may be stored on a processor, a memory device or on any other computer readable storage medium. Alternatively, the software code may be encoded in a computer readable electronic or optical signal. The code may be object code or any other code describing or controlling the functionality described herein. The computer readable storage medium may be a magnetic storage disk such as a floppy disk, an optical disk such as a CD-ROM, semiconductor memory or any other physical object storing program code or associated data.

The Hyper Advertising System algorithms may be implemented in a Hyper Operator device as shown in FIG. 8 and indicated as reference number 100. The Hyper Operator device 100 generally includes a Hyper Operator unit 102 and may also include an interface unit 104. The Hyper Operator unit 102 includes a processor 110 coupled to a memory device 116. The memory device 116 may be any type of fixed or removable digital storage device and (if needed) a device for reading the digital storage device including, floppy disks and floppy drives, CD-ROM disks and drives, optical disks and drives, hard-drives, RAM, ROM and other such devices for storing digital information such as that of in the Hyper Operator database or the information necessary for data mining. The processor 110 may be any type of apparatus used to process digital information. The memory device 116 stores at least one of the Hyper Advertising System procedures, the proprietary and standard tools, and the databases. Upon the relevant request from the processor 110 via a processor signal 122, the memory communicates one of the procedures along with any necessary information via a memory signal 124 to the processor 110. The processor 110 then performs the procedure.

The interface unit 104 generally includes an input device 114 and an output device 116. The output device 116 is any type of visual, manual, audio, electronic or electromagnetic device capable of communicating information from a processor or memory to a person or other processor or memory. Examples of display devices include, but are not limited to, monitors, speakers, liquid crystal displays, networks, buses, and interfaces. The input device 14 is any type of visual, manual, mechanical, audio, electronic, or electromagnetic device capable of communicating information from a person or processor or memory to a processor or memory. Examples of input devices include keyboards, microphones, voice recognition systems, trackballs, mice, networks, buses, and interfaces. Alternatively, the input and output devices 114 and 116, respectively, may be included in a single device such as a touch screen, computer, processor or memory coupled to the processor via a network. The information may be communicated to the memory device 116 from the input device 114 through the processor 110. Additionally, information may be communicated from the processor 110 to the display device 112.

While the invention has been described with reference to specific embodiments, the description is illustrative of the invention and not to be construed as limiting the invention. Various modifications and applications may occur to those skilled in the art without departing from the true spirit and scope of the invention as defined in the appended claims. Accordingly, this description and drawings are to be regarded in an illustrative rather than a restrictive sense.

1. A method of advertising comprising compensating customers having an account with a Hyper Operator that provides services for communication devices possessed by the customers for forwarding vendor advertisements to recipients known by the customers to be possibly interested in the advertisements, thereby referring the advertisements to the recipients, the recipients being other customers of the Hyper Operator, and the Hyper Operator amassing a database of characteristics and context information of the customers of the Hyper Operator.

2. The method of claim 1, further comprising the Hyper Operator independently generating pre-qualified leads based on characteristics of a particular advertisement, characteristics of a given customer, and context information of the given customer and sending an advertisement to one of the pre-qualified leads.

3. The method of claim 2, further comprising using only characteristics of the given customer made known by the given customer.

4. The method of claim 1, further comprising the Hyper Operator compensating the customers.

5. The method of claim 1, further comprising the Hyper Operator receiving an indication from an original customer that a particular advertisement is to be forwarded as well as an intended recipient of the particular advertisement and forwarding the particular advertisement to the intended recipient.

6. The method of claim 5, further comprising the Hyper Operator marking the particular advertisement delivered to the intended recipient as being forwarded from the original customer.

7. The method of claim 5, further comprising the Hyper Operator crediting the account of the original customer with a pre-arranged amount of microcredits and a corresponding amount of microdebits for the vendor when the intended recipient perceives the particular advertisement and issuing a credit to the account of the original customer when the microcredits accumulated by the original customer reach a predetermined amount.

8. The method of claim 7, further comprising the Hyper Operator permitting the predetermined amount of microcredits to be selectable by the original customer.

9. The method of claim 1, further comprising the Hyper Operator marking advertisements as being forwarded from an original customer before the recipients perceive the advertisements.

10. The method of claim 1, further comprising the Hyper Operator independently determining suitable prospects from a collection of customers each of which has individually indicated a willingness to receive specific types of advertisements to the Hyper Operator and sending referrals to the customers in the collection.

11. The method of claim 10, further comprising the Hyper Operator accumulating and aggregating context-aware purchase histories of the customers in the collection over time and using the accumulated information, along with proprietary tools and databases related to data mining and context-aware computing, to synthesize and present additional referrals to subscribing customers.

12. The method of claim 1, further comprising the Hyper Operator using context information in storage of purchase histories of the customers and in decisions regarding whether and in what way to make new referrals.

13. The method of claim 1, further comprising the Hyper Operator providing information of an individual customer to vendors only if a recipient of a referral acts on the referral.

14. The method of claim 1, further comprising limiting contact between the vendor and both the Hyper Operator and the customers of the vendor such that the vendor does business with the Hyper Operator for offer presentation and only sees orders from one of the customers and the Hyper Operator.

14. The method of claim 1, further comprising the Hyper Operator managing dynamic sale states in which sales are initiated, promoted via referrals, and cancelled at any time according to parameters of the Hyper Operator.

15. The method of claim 1, further comprising a given vendor compensating the Hyper Operator a fee for each advertisement delivered to the customers.

16. The method of claim 1, further comprising instituting a calling-party-pays system in which customers who refer advertisements to recipients are charged by the Hyper Operator for each referral.

17. The method of claim 1, further comprising allowing each customer to receive a particular advertisement only once.

18. The method of claim 1, further comprising limiting a number of allowable referrals and decreasing the number of allowable referrals each time the advertisement is referred.

19. The method of claim 1, further comprising compensating only a limited number of customers for referrals to one of an original customer first receiving a particular advertisement for referring the particular advertisement to referral customers and both the original customer and the referral customers for subsequent referrals, a later customer to whom the advertisement has been referred and who provides a referral being compensated at a reduced value as a function of generational distance from the referring customer.

20. A method of advertising comprising:
a vendor sending an advertisement to a referring customer of a Hyper Operator that provides services for a communication device possessed by the referring customer, the advertisement having parameters set by the vendor and being sent via the Hyper Operator to the communication device;
the Hyper Operator using the advertising parameters and a customer database of the Hyper Operator that includes information regarding offer parameters acceptable to customers in the database and context information of the customers to generate acceptable recipients;
the Hyper Operator transmitting the advertisement to the acceptable recipients;
a referring customer of the acceptable recipients forwarding the advertisement to a referral customer of the Hyper Operator known by the referring customer to be possibly interested in the advertisement; and
compensating the referring customer for forwarding of the advertisement to the referral customer.

21. The method of claim 20, further comprising:
adding the referral customer as input, the Hyper Operator using the customer database to generate a set of additional acceptable recipients; and
the Hyper Operator transmitting the advertisement to the additional acceptable recipients.

22. The method of claim 21, further comprising:
the referral customer forwarding the advertisement to a secondary referral customer of the Hyper Operator known by the referral customer to be possibly interested in the advertisement;
adding the secondary referral customer as input, the Hyper Operator using the customer database to generate a second set of additional acceptable recipients; and
the Hyper Operator transmitting the advertisement to the additional acceptable recipients,
the Hyper Operator compensating the referral customer for forwarding of the advertisement.

23. The method of claim 20, further comprising compensating the referring customer only after the referral customer perceives the advertisement.

24. The method of claim 20, further comprising compensating the referring customer only for referral customers directly referred to by the referring customer.

25. The method of claim 20, further comprising compensating the referring customer only for referral customers directly referred to by the referring customer and a limited number of additional referral customers indirectly referred to by the referring customer, the compensation to the referring customer for the additional referral customers indirectly referred to by the referring customer being limited by permitting compensation for a maximum number of indirect referrals that decrease and eventually stop with increasing generational distance from the referring customer.

26. The method of claim 20, further comprising compensating the referring customer by sending accounting information about the referring customer to the Hyper Operator and generating a microcredit for the referring customer and a corresponding microdebit for the vendor.

27. The method of claim 26, further comprising the vendor accumulating microdebits, the Hyper Operator billing the vendor for the accumulated microdebits and clearing the accumulated microdebits on a periodic basis.

28. The method of claim 27, further comprising the referring customer accumulating microcredits, the Hyper Operator crediting the referring customer for the accumulated microcredits and clearing the accumulated microcredits when a money value of the microcredits reaches a predetermined level.

29. The method of claim 20, further comprising allowing each customer to receive a particular advertisement only once.

30. The method of claim 20, further comprising instituting a calling-party-pays system in which customers who refer advertisements to recipients are charged by the Hyper Operator for each referral.

31. The method of claim 20, further comprising limiting a number of allowable referrals generated by each customer and decreasing the number of allowable referrals with increasing generational distance from the referring customer.

32. The method of claim 20, further comprising compensating only the referring customer originally receiving the advertisement from the vendor for any referrals.

33. The method of claim 20, further comprising compensating both the referring customer originally receiving the advertisement from the vendor for any referrals and referred customers for subsequent referrals, a later customer to whom the advertisement has been referred and who provides a referral being compensated at a reduced value as a function of generational distance from the referring customer.

34. The method of claim 20, further comprising the Hyper Operator learning from customer referral and purchasing behavior to create a store of specialized knowledge about customers.

35. The method of claim 34, further comprising using the created store of specialized knowledge about the customers to enhance vendor initiatives.

36. The method of claim 34, further comprising using the created store of specialized knowledge about the customers to select additional referrals beyond referrals initiated by the customers.

37. The method of claim 34, further comprising using the created store of specialized knowledge about the customers to more customize a nature, form, timing, and content of referrals.

38. The method of claim 20, further comprising providing intermediary services for customer-initiated advertising referrals.

39. The method of claim 20, further comprising marking advertisements as being forwarded from the referring customer before the referral customer perceives the advertisement.

40. A method of advertising comprising:
a vendor sending an advertisement to a referring customer of a Hyper Operator that provides services for a communication device possessed by the referring customer, the advertisement having parameters set by the vendor and being sent via the Hyper Operator to the communication device;
the Hyper Operator using the advertising parameters and a customer database of the Hyper Operator that includes information regarding offer parameters acceptable to customers in the database and context information of the customers to generate acceptable recipients;
the Hyper Operator transmitting the advertisement to the acceptable recipients;
a referring customer of the acceptable recipients forwarding the advertisement to referral customers of the Hyper Operator known by the referring customer to be possibly interested in the advertisement; and
the Hyper Operator compensating a limited number of customers for referrals, the compensation being limited to one of compensating only the referring customer for forwarding of the advertisement to the referral customers only after the referral customers perceive the advertisement and compensating both the referring customer and the referral customers for subsequent referrals only after the subsequent referrals perceive the advertisement, a later customer to whom the advertisement has been referred and who provides a referral being compensated at a reduced value as a function of generational distance from the referring customer.

41. The method of claim 40, further comprising instituting a calling-party-pays system in which customers who refer advertisements to recipients are charged by the Hyper Operator for each referral.

42. The method of claim 41, further comprising the Hyper Operator adding the referral customers as input, using the customer database to generate a set of additional acceptable recipients, and transmitting the advertisement to the additional acceptable recipients.

43. The method of claim 42, further comprising the Hyper Operator adding the subsequent referrals as input, using the customer database to generate a second set of additional acceptable recipients, and transmitting the advertisement to the additional acceptable recipients.

44. The method of claim 41, further comprising compensating the referring customer by sending accounting information about the referring customer to the Hyper Operator and generating a microcredit for the referring customer and a corresponding microdebit for the vendor, the vendor accumulating microdebits, the Hyper Operator billing the vendor for the accumulated microdebits and clearing the accumulated microdebits on a periodic basis, the referring customer accumulating microcredits, the Hyper Operator crediting the referring customer for the accumulated microcredits and clearing the accumulated microcredits when a money value of the microcredits reaches a predetermined level.

45. The method of claim 41, further comprising the Hyper Operator allowing each customer to receive a particular advertisement only once.

46. The method of claim 41, further comprising the Hyper Operator limiting a number of allowable referrals generated by each customer and decreasing the number of allowable referrals with increasing generational distance from the referring customer.

47. The method of claim 41, further comprising the Hyper Operator learning from customer referral and purchasing behavior to create a store of specialized knowledge about customers.

48. The method of claim 47, further comprising using the created store of specialized knowledge about the customers to enhance vendor initiatives.

49. The method of claim 47, further comprising using the created store of specialized knowledge about the customers to select additional referrals beyond referrals initiated by the customers.

50. The method of claim 47, further comprising using the created store of specialized knowledge about the customers to more customize a nature, form, timing, and content of referrals.

51. A computer readable storage medium storing computer readable program code for providing advertisements from at least one vendor and customers of a Hyper Operator that supplies service to communication devices possessed by the customers, the computer readable program code comprising a computer code that implements:
generation of acceptable recipients of the advertisement using advertising parameters and a customer database that includes information regarding offer parameters acceptable to customers in the database and context information of the customers and transmission of the advertisement to the acceptable recipients; and
compensation of a referring customer of the acceptable recipients who forwards the advertisement to a referral customer of the Hyper Operator through the Hyper Operator and known by the referring customer to be possibly interested in the advertisement.

52. The computer readable program code of claim 51, further comprising computer code that implements amassing of the customer database.

53. The computer readable program code of claim 51, further comprising computer code that implements addition of the referral customer as input, generation of a set of additional acceptable recipients from the referral customer, and transmission of the advertisement to the additional acceptable recipients.

54. The computer readable program code of claim 51, further comprising computer code that implements compensation of the referring customer one of only for referral customers directly referred to by the referring customer and only for referral customers directly referred to by the referring customer as well as a limited number of additional referral customers indirectly referred to by the referring customer, the compensation to the referring customer for the additional referral customers indirectly referred to by the referring customer being limited by permitting compensation for a maximum number of indirect referrals that decrease and eventually stop with increasing generational distance from the referring customer.

55. The computer readable program code of claim 51, further comprising computer code that implements compensation of the referring customer by generation of a microcredit for the referring customer and a corresponding microdebit for the vendor.

56. The computer readable program code of claim 51, further comprising computer code that implements billing accumulating microdebits to the vendor and clearing the accumulated microdebits on a periodic basis.

57. The computer readable program code of claim 56, further comprising computer code that implements accumulating microcredits to the referring customer, crediting the referring customer for the accumulated microcredits and clearing the accumulated microcredits when a money value of the microcredits reaches a predetermined level.

58. The computer readable program code of claim 51, further comprising computer code that implements allowing each customer to receive a particular advertisement only once.

59. The computer readable program code of claim 51, further comprising computer code that implements instituting a calling-party-pays system in which customers who refer advertisements to recipients are charged for each referral.

60. The computer readable program code of claim 51, further comprising computer code that implements limiting a number of allowable referrals generated by each customer and decreasing the number of allowable referrals with increasing generational distance from the referring customer.

61. The computer readable program code of claim 51, further comprising computer code that implements compensating only the referring customer originally receiving the advertisement from the vendor for any referrals.

62. The computer readable program code of claim 51, further comprising computer code that implements compensating both the referring customer originally receiving the advertisement from the vendor for any referrals and referred customers for subsequent referrals, a later customer to whom the advertisement has been referred and who provides a referral being compensated at a reduced value as a function of generational distance from the referring customer.

63. The computer readable program code of claim 51, further comprising computer code that implements learning from customer referral and purchasing behavior to create a store of specialized knowledge about customers.

64. The computer readable program code of claim 63, further comprising computer code that implements enhancing vendor initiatives using the created store of specialized knowledge about the customers.

65. The computer readable program code of claim 63, further comprising computer code that implements selection of additional referrals beyond referrals initiated by the customers using the created store of specialized knowledge about the customers.

66. The computer readable program code of claim 63, further comprising computer code that implements customization of a nature, form, timing, and content of referrals using the created store of specialized knowledge about the customers.

67. The computer readable program code of claim 51, further comprising computer code that implements providing intermediary services for customer-initiated advertising referrals.

68. An electronic unit housing a Hyper Operator that provides services for communication devices possessed by customers having an account with the Hyper Operator, the electronic unit comprising:
a transmitter/receiver through which the electronic unit communicates with external sources including vendors and the customers, the transmitter/receiver configured to receive advertisements with parameters set by the vendor and transmit the advertisements to selected customers;
a memory that is configured to amass a customer database of characteristics and context information of the customers;
a processor that is configured to use the customer database and advertisement parameters to determine referring customers to whom the advertisements are transmitted and configured to set compensation for the referring customers who refer advertisements to referral customers known by the referring customers to be possibly interested in the advertisements; and
an interface through which internal elements of the electronic unit communicate.

69. The electronic unit of claim 68, wherein the customer database maintained by the memory includes information regarding offer parameters acceptable to the customers.

70. The electronic unit of claim 68, wherein the Hyper Operator limits a total number of referral customers from each of the referring customers.

71. The electronic unit of claim 68, wherein the Hyper Operator limits the compensation to one of only the referring customers and to both the referring and referral customers who subsequently refer the advertisements to other customers.

72. The electronic unit of claim 71, wherein the Hyper Operator reduces the compensation of referral customers as a function of generational distance from the referring customer.

73. The electronic unit of claim 68, wherein the Hyper Operator only allows a particular customer to receive a particular advertisement only once.

74. The electronic unit of claim 68, wherein the memory includes characteristics and context information of the customers, the Hyper Operator independently generates pre-qualified leads based on the characteristics and context information of the customers stored in the memory and characteristics of a particular advertisement, and transmits the particular advertisement to the pre-qualified leads.

75. The electronic unit of claim 74, wherein the characteristics and context information of the customers that are stored in the memory include a willingness specified by each customer to receive specific types of advertisements.

76. The electronic unit of claim 74, wherein the memory includes an accumulation and aggregation of context-aware purchase histories of the customers over time and the Hyper Operator uses the accumulated information, along with proprietary tools and databases related to data mining and context-aware computing, to synthesize and present additional referrals to subscribing customers.

77. The electronic unit of claim 68, wherein the Hyper Operator uses context information contained in the memory in storage of purchase histories of the customers and in decisions regarding whether and in what way to make new referrals.

78. The electronic unit of claim 68, wherein the Hyper Operator isolates the customers and the vendors such that information of a particular customer is provided to a particular vendor only if the particular customer acts on an advertisement of the particular vendor.

78. The electronic unit of claim 68, wherein the Hyper Operator manages dynamic sale states in which sales are initiated, promoted via referrals, and cancelled at any time according to information stored in the memory.

79. The electronic unit of claim 68, wherein the Hyper Operator receives an indication from one of the referring customers that a particular advertisement is to be forwarded as well as an intended referral customer of the particular advertisement, marks the particular advertisement as being forwarded from the one of the referring customers, and forwards the particular advertisement to the intended referral customer.

80. The electronic unit of claim 68, wherein the Hyper Operator credits an account of a particular referring customer with a pre-arranged amount of microcredits and debit a corresponding amount of microdebits from an account of a particular vendor for each advertisement of the particular vendor forwarded by the particular referring customer that qualifies for crediting and debiting, issues a credit to the account of the particular referring customer when the microcredits accumulated by the particular referring customer account reach a predetermined amount, and the credits, microcredits, debits, and microdebits are stored in the memory.

81. The electronic unit of claim 80, wherein the Hyper Operator indicates to the particular referring customer when the credit has been issued.

82. The electronic unit of claim 80, wherein the Hyper Operator charges a particular vendor compensation for each advertisement of the particular vendor that is delivered to the customers.

83. The electronic unit of claim 80, wherein the Hyper Operator institutes a calling-party-pays system in which the referring customers who refer advertisements to the referral customers are charged for each referral.
